(19) United States
(12) Patent Application Publication
(10) Pub. No.: US 2011/0035221 A1
(43) Pub. Date: Feb. 10, 2011

(54) Monitoring An Audience Participation Distribution

(76) Inventors: Tong Zhang, San Jose, CA (US); Hui Chao, San Jose, CA (US); Xuemei Zhang, Mountain View, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/537,900

(22) Filed: Aug. 7, 2009

(51) Int. Cl. G10L 17/00; G06K 9/00

(52) U.S. Cl. 704/246; 382/118; 382/103; 704/E15.001

(57) ABSTRACT

Apparatus for monitoring an audience participation distribution at an event comprising a speech activity module operable to generate speech data representing speech detected at the event, a speaker identification module operable to determine, using the speech data, a first speaker who has contributed to the detected speech, and a processing unit operable to generate speaker data representing a value for the time that the first speaker has contributed to the detected speech and to output distribution data based on the speaker data representing a measure of the participation for the first speaker at the event.

### BACKGROUND

It is often desirable to be able to monitor the participation distribution of the attendees in a class or meeting, for example to make sure that attendees are actively involved and have opportunities to participate where appropriate. Currently, there is no accurate and comprehensive real-time system which can be used to determine a participation distribution at an event, meeting or class.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is a schematic representation of a component of an audio monitoring system according to an embodiment;

FIG. 2 is a schematic representation of a component of a video monitoring system according to an embodiment;

FIG. 3 is a schematic representation of a portable monitoring device according to an embodiment; and

FIG. 4 is a schematic of a functional representation of a system according to an embodiment.

### DETAILED DESCRIPTION

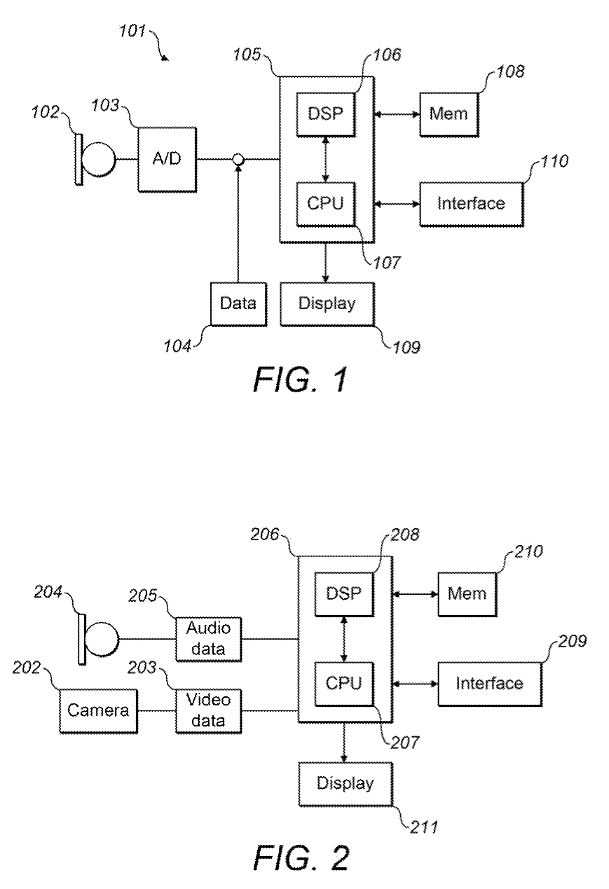

According to an embodiment, there is provided a system and method to automatically monitor the participation distribution of a class or a meeting by analyzing an audio and/or video stream in real-time. FIG. 1 is a schematic representation of a component of an audio monitoring system according to an embodiment. The device of FIG. 1 comprises an audio recorder module 101. The audio recorder module comprises a microphone 102 for converting audible sounds into digital audio data. An analogue audio signal can be converted to digital data 104 using an analogue-to-digital converter 103. The microphone can be an electrostatic or electrodynamic microphone for example and can be directional or non-directional. Other alternatives are possible. The audio recorder module further comprises a controller module 105 which can comprise a digital signal processor (DSP) 106 and processor 107. The controller uses a memory 108 such as RAM or other suitable memory to store captured audio data. The captured audio data is analyzed using the processor in order to identify speakers and calculate data representing a participation distribution.

The module 101 optionally comprises a display device 109 and an interface module 110. The display device 109 can be used to output the data representing the participation distribution. The interface 110 can be used to transfer data from module 101 to an external device such as a computing apparatus (not shown). The interface can be a wired or wireless interface for example. It will be appreciated that module 101 can also optionally include further functionality.

In order to generate distribution data representing a participation distribution for an event from which the audio data 104 originates, a data analysis procedure according to an embodiment comprises the following:

Speech activity detection—Speech is detected in the audio data and discriminated from background noise by processing the audio data 104 using the DSP and CPU. The detection and discrimination of speech can be performed using the method described in, for example, B. V. Harsha, “A noise robust speech activity detection algorithm”, Proceedings of 2004 International Symposium on Intelligent Multimedia, Video and Speech Processing, 20-22 Oct. 2004 Page(s): 322-325, the contents of which are incorporated herein in their entirety by reference. The method can be implemented in hardware or software, and stored in memory 108 or in a dedicated hardware processor such as an ASIC for example. Other alternatives are possible as will be appreciated by those skilled in the art.

Speaker identification—To detect speaker changes, existing approaches can be used. For example, the approach described in A. Malegaonkar, A. Ariyaeeinia, et al. “Unsupervised speaker change detection using probabilistic pattern matching”, IEEE Signal Processing Letters, Volume 13, Issue 8, August 2006 Page(s): 509-512, the contents of which are incorporated herein in their entirety by reference, can be used. Alternatively, speaker change detection can be embedded in speaker identification. That is, at the beginning of the speech of a new speaker, a segment of the speech can be used to build a model of the speaker. Subsequent segments of speech are compared with the generated speaker model until the match fails, which implies that a speaker change has occurred.

At each speaker change, the system can identify whether this is a new speaker or an existing speaker by comparing speech samples of the current speaker with existing speaker models. For a new speaker, a model is built using speech samples of the speaker. Data representing a model of a speaker can be stored in memory 108, or in a further standalone dedicated memory of the system (not shown). Such a standalone memory can be remote from the system, for example a server situated remotely, such that the system 101 is required to connect to the memory using interface 110 in order to retrieve the model data. Each speaker is assigned a label. Audio features and speaker models used in known speaker identification approaches can be used. For example, the approach described in D. A. Reynolds, R. C. Rose, “Robust text-independent speaker identification using Gaussian mixture speaker models”, IEEE Transactions on Speech and Audio Processing, Volume 3, Issue 1, January 1995 Page(s): 72-83, the contents of which are incorporated herein in their entirety by reference, can be used. The approach can be implemented in hardware or software, and stored in memory 108 or in a dedicated hardware processor such as an ASIC for example. Other alternatives are possible as will be appreciated by those skilled in the art.

Participation distribution calculation—The processor 107 of system 101 determines the total speaking time of each speaker by generating speaker data representing the total duration that a particular speaker has contributed to the speech detected, and calculates the percentage of the speakers speaking time over the total speaking time of all speakers. Alternatively, the system may only count the number of times each speaker makes a speech, and calculate the percentage of the number of speeches a speaker has made over the total number of speeches all speakers have made. The speaker data can be generated on-the-fly—that is to say as audio data 104 is received during an event, the system can continuously, and in real time, update the time that a particular speaker has been detected as contributing to the detected speech of the event. As the system detects a change of speaker from a first speaker to a second speaker, it can record in memory 108 the time up to that point that the first speaker has spoken, and this data can be augmented if the system detects that the first speaker contributes again during the event.

Other speaker-particular statistics may also be computed for each speaker from the speech data, such as voice volume, speed of speech, the prosody of speech and number of interruptions by analyzing the speech signal, and are included as supplementary information to the participation data. For example, the voice volume can be calculated from the average energy of the audio waveform of the speech over a period of time. The speed of speech can be derived from peaks in the energy and/or zero-crossing-rate features which represent the frequency of voiced and/or non-voiced components in a speech. Interruptions can be detected using the method as described in Liang et al, “Interruption point detection of spontaneous speech using prior knowledge and multiple features”, Proceedings of 2008 International Conference on Multimedia and Expo, 23-26 Jun. 2008 Page(s): 1457-1460, the contents of which are incorporated herein in their entirety by reference. The distribution can be updated substantially continuously, once every desired fixed time interval (such as one minute, one second etc), or at each speaker change.

Display participation distribution—The participation distribution can be displayed as a pie chart, or a rank list for example. Other alternatives are possible. Such data can be shown only to the teacher/organizer, or shown to the whole room, including a portion or all of the attendees. Each attendee may be labeled as speaker A, speaker B, etc. Or, alternatively, at the beginning of the class/meeting, each attendee can announce his/her name. The system can remember the name and the voice of the person, and labels each speaker with his/her name. Using known face recognition techniques, the system can also associate each speaker with a face image recorded in the video.

A different chart may be viewed by each speaker and can compare his/her performance to an average or against the rest of the participants. This is useful for helping individuals to improve their participation or as a reminder for themselves (talk louder, talk more, slow down, etc.).

FIG. 2 is a schematic representation of a component 201 of a video monitoring system according to an embodiment. The system of FIG. 2 comprises a video camera 202. The camera can comprise any conventional video recording apparatus such as a CCD or CMOS sensor capable of generating video data 203. System 201 comprises a microphone 204 capable of generating audio data 205. Video data 203 and related audio data 205 are input to a control module 206 comprising a processor 207 and DSP 208 communicatively coupled to one another. The control module 206 is communicatively coupled to a memory module 210 which comprises RAM or other suitable memory. The system 201 can optionally comprise an interface module 209 operable to output processed video data using a wired or wireless communications protocol.

The controller module 206 can be communicatively coupled to a display unit 211 for displaying information representing a participation distribution for an event.

Audio data 205 is processed using controller 206 in the same way as described above in order to generate data representing a participation distribution for an event. According to an embodiment, speaker identification may be enhanced by integrating visual information using the video data 203 captured using the video system of FIG. 2. That is to say, besides audio data processing using a system as described with reference to FIG. 1, the system can use techniques such as face identification/recognition and lip movement detection to improve speaker identification accuracy. One of the existing face recognition methods can be used, such as the ones introduced in K. Messer, J. Kittler, M. Sadeghi, et al., “Face authentication test on the BANCA database,” Proc. of International Conf. on Pattern Recognition, vol. 4, pp. 523-532, August 2004, the contents of which are incorporated herein in their entirety by reference. For lip movement detection, an example method can be found in S. Lee, J. Park, E. Kim, “Speech Activity Detection with Lip Movement Image Signals,” Proc. of IEEE Pacific Rim Conference on Communications, Computers and Signal Processing, 22-24 Aug. 2007 Page(s): 403-406, the contents of which are incorporated herein in their entirety by reference. The additional data to enable the augmentation is generated using the system of FIG. 2 in which camera 202 is used to generate data 203 representing video of the event being monitored. The recognition of a talking head by combining lip movement detection with face recognition helps to confirm the result of speaker identification from speech signal analysis. This multimodal speaker identification is expected to achieve better accuracy than using information from one single modal.

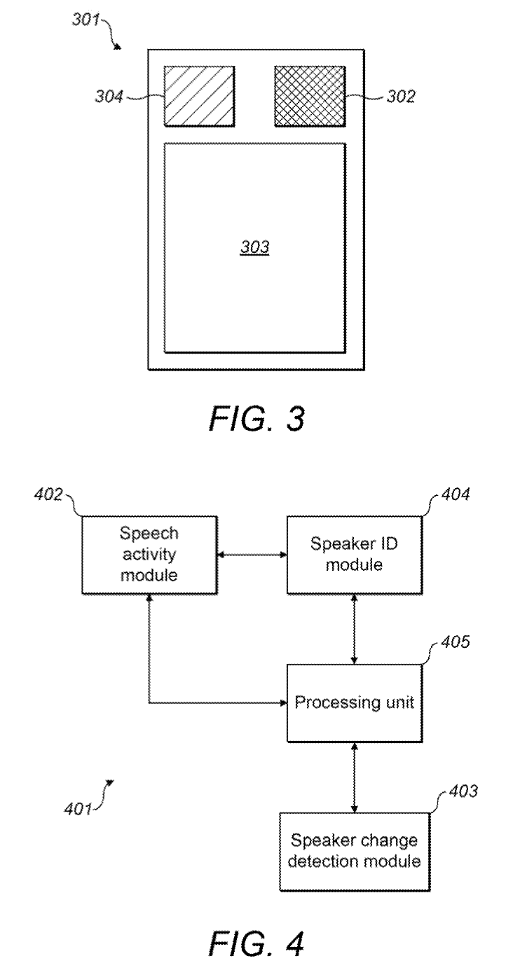

The system may be a portable device or a built-in device in the classroom/conference room. Accordingly, FIG. 3 is a schematic representation of a portable monitoring device. The device 301 comprises a microphone 302 for generating audio data. The device 301 further comprises a display 303 operable to present information representing an audience participation distribution to a user of the device. Any suitable display can be used, such as an LED or LCD display for example. Other alternatives are possible as will be appreciated.

The device 301 comprises a DSP, processor and memory (not shown) which are operable to process the audio data generated by the microphone 302, to generate data which is used to determine an audience participation distribution as described above.

Optionally, device 301 can comprise a video camera unit 304 which can be used to generate video data of an event in order to provide video data which can be used to augment and enhance the participation distribution data generated using the audio data. Device 301 can also comprise an interface, such as a wired or wireless interface which can be used to upload and download data from and to the device respectively.

FIG. 4 is a schematic of a functional representation of a system according to an embodiment. A system 401 for generating data representing a participation distribution for audience members at an event comprises a speech activity module 402, a separate speaker change detection module 403 or alternatively a speaker change detector embedded in a speaker identification module 403 with continuous speaker identification operation, a speaker identification module 404 and a processing unit 405. A face recognition engine and lip movement detector may be embedded in the speaker identification module. The speech activity module 402 is operable to generate speech data representing speech detected at the event. The speaker identification module 404 is operable to determine, using the speech data and face image data in video, a first speaker who has contributed to the detected speech. The processing unit 405 is operable to generate speaker data representing a value for the time that the first speaker has contributed to the detected speech and to output distribution data based on the speaker data representing a measure of the participation for the first speaker at the event.

According to an embodiment, the speech activity module 402 and speaker identification module 404 are implemented using the DSP (106, 208) and CPU (107, 207). The processing unit 405 is implemented using the CPU (107, 207).

It is to be understood that the above-referenced arrangements are illustrative of the application of the principles disclosed herein. It will be apparent to those of ordinary skill in the art that numerous modifications can be made without departing from the principles and concepts of this disclosure, as set forth in the claims below.

What is claimed is:

1. Apparatus for monitoring an audience participation distribution at an event comprising:
a speech activity module operable to generate speech data representing speech detected at the event;
a speaker identification module operable to determine, using the speech data, a first speaker who has contributed to the detected speech; and
a processing unit operable to generate speaker data representing a value for the time that the first speaker has contributed to the detected speech and to output distribution data based on the speaker data representing a measure of the participation for the first speaker at the event.

2. Apparatus as claimed in claim 1, wherein the processing unit is further operable to:
generate identification data for the first speaker based on a parameter of the first speaker's speech, and use the identification data to label subsequent speech detected from the first speaker accordingly.

3. Apparatus as claimed in claim 1, wherein the processing unit is operable to generate speaker data substantially continuously, once every fixed time interval or at a time corresponding to a change of speaker.

4. Apparatus as claimed in claim 1, wherein the processing unit is further operable to use the speech data to generate a measure for one or more of voice volume, speech speed, the prosody of speech and number of interruptions.

5. Apparatus as claimed in claim 1 further comprising:
a video recording module operable to generate video data representing video of the audience, the video recording module operable to feed the video data to the processing unit, and wherein the processing unit is operable to process the video data in order to generate data for the first speaker representing an identification of the first speaker's face.

6. Apparatus as claimed in claim 5, wherein the processing unit is further operable to use the video data to determine the identity of a speaker using face recognition and lip movement detection.

7. Apparatus as claimed in claim 6, wherein the processor is further operable to use the video data in order to detect movement of the lips to improve recognition accuracy of the first speaker.

8. A method for monitoring an audience participation distribution at an event comprising:
generating speech data representing speech detected at the event;
determining, using the speech data, a first speaker who has contributed to the detected speech; and
generating speaker data representing a value for the time that the first speaker has contributed to the detected speech; and
generating distribution data based on the speaker data representing a measure of the participation for the first speaker at the event.

9. A method as claimed in claim 8, further comprising:
generating identification data for the first speaker based on a parameter of the first speaker's speech; and
using the identification data to label subsequent speech detected from the first speaker accordingly.

10. A method as claimed in claim 8, wherein speaker data is substantially continuously generated, once every fixed time interval or at a time corresponding to a change of speaker.

11. A method as claimed in claim 8, further comprising:
using the speech data to generate a measure for one or more of voice volume, speech speed, the prosody of speech and number of interruptions.

12. A method as claimed in claim 8, further comprising:
generating video data representing video of the audience; and
processing the video data in order to generate data for a first speaker representing an identification of the first speaker's face.

13. A method as claimed in claim 12, further comprising:
using the video data to determine the identity of a speaker using face recognition and lip movement detection.

14. A method as claimed in claim 13, further comprising:
using the video data in order to detect movement of the lips to improve recognition accuracy of the first speaker.
